(19) United States
(12) Patent Application Publication
(10) Pub. No.: US 2026/0037774 A1
(43) Pub. Date: Feb. 5, 2026

(54) PRIOR-GUIDED MIXTURE OF EXPERTS

(71) Applicant: QUALCOMM Incorporated, San Diego, CA (US)

(72) Inventors: Babak EHTESHAMI BEJNORDI, Amsterdam (NL); Amélie Marie Estelle ROYER, Paris (FR)

(21) Appl. No.: 18/790,996

(22) Filed: Jul. 31, 2024

(51) Int. Cl. G06N 3/045; G06N 3/0499

(52) U.S. Cl. CPC G06N 3/045; G06N 3/0499

(57) ABSTRACT

Systems and techniques are described herein for language processing. For example, a computing device can determine, using a router of a mixture of experts (MOE) machine learning model, a distribution of tokens for a respective category associated with each expert layer of a plurality of expert layers of the MOE model. The computing device can train each expert layer of the plurality of expert layers based on matching the distribution of tokens associated with each respective expert layer of the plurality of expert layers to a prior distribution of the tokens for the respective category associated with each respective expert layer of the plurality of expert layers.

### FIELD

The present disclosure generally relates to language processing. For example, aspects of the present disclosure relate to prior-guided mixture of experts (MOEs) for machine-learning processing (e.g., language processing, vision or image processing, etc.).

### BACKGROUND

Deep learning machine learning models (e.g., neural networks, such as large language models (LLMs)) can be used to perform a variety of tasks, such as detection and/or recognition of natural language, and natural language processing, among other natural language tasks. Deep learning machine learning models can be versatile and can achieve high quality results in a variety of tasks. However, while deep learning machine learning models can be versatile and accurate, the models can be large and slow, and generally have high memory demands and computational costs. In many cases, the computational complexity of the models can be high, and the models can be difficult to train. In some cases, machine learning models may utilize one or more transformers. Tokens are used by a transformer as its base units for reasoning. For example, a natural language word may be associated with a token, which can be input into the transformer for processing.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for machine-learning processing (e.g., language processing, vision or image processing, etc.). In some aspects, an apparatus for machine-learning processing is provided. The apparatus includes at least one memory and at least one processor coupled to the at least one memory and configured to: determine, using a router of a mixture of experts (MOE) machine learning model, a distribution of tokens for a respective category associated with each expert layer of a plurality of expert layers of the MOE model; and train each expert layer of the plurality of expert layers based on matching the distribution of tokens associated with each respective expert layer of the plurality of expert layers to a prior distribution of the tokens for the respective category associated with each respective expert layer of the plurality of expert layers.

In some aspects, a method of machine-learning processing is provided. The method includes: determining, by a router of a mixture of experts (MOE) machine learning model, a distribution of tokens for a respective category associated with each expert layer of a plurality of expert layers of the MOE model; and training each expert layer of the plurality of expert layers based on matching the distribution of tokens associated with each respective expert layer of the plurality of expert layers to a prior distribution of the tokens for the respective category associated with each respective expert layer of the plurality of expert layers.

In some aspects, a non-transitory computer-readable medium is provided having stored thereon instructions that, when executed by at least one processor, cause the at least one processor to: determine, using a router of a mixture of experts (MOE) machine learning model, a distribution of tokens for a respective category associated with each expert layer of a plurality of expert layers of the MOE model; and train each expert layer of the plurality of expert layers based on matching the distribution of tokens associated with each respective expert layer of the plurality of expert layers to a prior distribution of the tokens for the respective category associated with each respective expert layer of the plurality of expert layers.

In some aspects, an apparatus for machine-learning processing is provided. The apparatus includes: means for determining a distribution of tokens for a respective category associated with each expert layer of a plurality of expert layers of a mixture of experts (MOE) machine learning model; and means for training each expert layer of the plurality of expert layers based on matching the distribution of tokens associated with each respective expert layer of the plurality of expert layers to a prior distribution of the tokens for the respective category associated with each respective expert layer of the plurality of expert layers.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating a comparison between an example dense model and an example sparse model, in accordance with some aspects of the disclosure.

FIG. 2 is a diagram illustrating an example of MOE token choice routing, in accordance with some aspects of the disclosure.

FIG. 3 is a diagram illustrating an example of a Beta distribution for three experts, in accordance with some aspects of the disclosure.

FIG. 4 is a diagram illustrating an example of three Beta distributions for three experts, respectively, in accordance with some aspects of the disclosure.

FIG. 5 is a diagram illustrating another example of a Beta distribution for three experts, in accordance with some aspects of the disclosure.

FIG. 6 is a diagram illustrating an example of a Dirichlet distribution and plots of example Dirichlet densities, in accordance with some aspects of the disclosure.

FIG. 7 is a diagram illustrating an example of producing a data distribution for three experts, where all three experts are active, in accordance with some aspects of the disclosure.

FIG. 8 is a diagram illustrating an example of producing a data distribution for three experts, where two of the three experts are active, in accordance with some aspects of the disclosure.

FIG. 9 is a diagram illustrating an example of routing tokens to experts based on temporal expert activation patterns, in accordance with some aspects of the disclosure.

FIG. 10 is a diagram illustrating a comparison between an example data distribution for three experts produced using the systems and techniques and an example data distribution for three experts produced using a load-balancing loss, in accordance with some aspects of the disclosure.

FIG. 11 is a block diagram of an example transformer, in accordance with some aspects of the disclosure.

FIG. 12 is a flow diagram illustrating an example of a process for prior-guided MOEs, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, deep learning machine learning models (e.g., neural networks, such as large language models (LLMs)) can be used to perform a variety of tasks, such as natural language processing (e.g., detection, recognition, generation, etc. of natural language), vision processing (e.g., image and/or video processing), among other tasks. Deep learning machine learning models can be versatile and can achieve high quality results in a variety of tasks. While deep learning machine learning models can be versatile and accurate, the models can be large and slow. For example, deep learning machine learning models typically have high memory demands and computational complexity/costs, which can make such models difficult to train.

In some cases, machine learning models may include one or more transformer models. Tokens can be utilized by a transformer model as its base unit for reasoning. For example, a natural language word can be associated with a token, which can be input into the transformer for processing. A transformer model improves language processing with its unique architecture. The transformer architecture has two main non-embedding components, including an attention component and a feedforward network (FFN). For example, the attention component captures interdependencies between words (e.g., natural language words), while the FFN non-linearly transforms each input token (e.g., each associated with a word) independently.

The FFN enhances the capability of the transformer to handle diverse and complex linguistic tasks with efficiency and effectiveness. The FFN includes two linear fully connected layers (e.g., a multi-layer perceptron (MLP)) that transform the input data. Positioned within both the encoder and decoder modules of the transformer, the FFN refines data processed by the attention mechanisms of the transformer. By systematically refining the output from the attention layers of the transformer, the FFN helps to maintain high performance of the transformer across different natural language processing applications.

The capacity of a machine learning model (e.g., a neural network) to absorb information is limited by the number of parameters of the model. As a consequence, finding more effective ways to increase model parameters has become a trend in deep learning research. Mixture of Experts (MOEs) is a type of conditional computation where parts of the network are activated on a per-example basis. MOEs can be used as a way to dramatically increase model capacity without a proportional increase in computation. For example, in sparsely activated variants of MOE models, a subset of experts is selected on a per-token (or per-example) basis, which creates sparsity in the network. Such models have demonstrated better scaling in multiple domains and better retention capability in a continual learning setting.

MOEs operate by adopting a number of experts (e.g., with each expert being a sub-network) and activating one or more experts for each input token. A gating network (e.g., a router or routing network) can be optimized to route each token to the most suited expert(s) for a given token. Depending upon how tokens are mapped to experts, MOEs can be sparse or dense. Sparse MOEs only select a subset of experts when routing each token, which reduces computational cost as compared to dense MOEs.

LLMs improve machine intelligence by enabling a wide range of processing tasks, such as natural language processing tasks, vision processing tasks, etc. However, deploying LLMs on some devices (e.g., mobile devices) presents a challenge due to the large number of LLM parameters and significant memory and compute costs of LLMs. The use of MOEs can significantly increase the number of parameters in a machine learning model (e.g., an LLM) without a proportional increase in computation during training and inference. Such computational efficiency can be achieved by selectively activating (e.g., as in a sparse model) only a subset of parameters (or experts) for each input. MOEs for LLMs can be designed by replacing an FFN layer in a transformer block with a set of expert FFN layers. As noted above, an MOE model can include a gating/routing mechanism (e.g., a router or routing network) that dynamically determines which expert (or combination of experts) is best suited for a given input during inference.

Although MOEs (e.g., in a sparse model) provide computational benefits (e.g., as compared to dense models), MOEs have several challenges for training and inference (e.g., on-device inference). For example, training the large number of parameters of an MOE (e.g., a multi-billion parameter MOE) presents challenges related to stability and training time efficiency. In some cases, issues such as “expert collapse” (e.g., when only one expert is being used, and the remaining experts are not used and “collapse”) and prolonged training times can emerge. Training the model with conventional load balancing losses can lead to redundancy and suboptimal expert performance.

MOEs can also have issues that arise during inference. For example, during on-device inference, all of the model parameters are loaded in random-access memory (RAM). For example, given an MOE architecture (e.g., Mixtral 8x7B), there needs to be enough random-access memory (RAM), such as video random-access memory (VRAM), to store a dense parameter model (e.g., a dense 47B parameter model, corresponding to 22 gigabytes (GB) in 4-bit). As such, for memory-constrained devices, alternative solutions may be needed, such as pre-caching of the experts. The lack of consistency in activation of experts in the temporal dimension can lead to a significant cache miss rate.

MOEs can be trained for batch deployment on servers (e.g., for inference), running across a large number of devices, where each device hosts a single (or a subset) of experts. In such a scenario, it is desirable to have all experts activated in a balanced way to maximally use available resources. However, for resource-constrained devices (e.g., mobile devices, XR devices, etc.) that may generate one token at a time, alternative priors for executing the experts may be needed. Improved predictability of the chosen experts and temporal consistency is desirable in such cases. For example, improved systems and techniques that employ priors for executing experts in MOEs can be beneficial (e.g., for resource constrained devices and/or other devices or systems).

In one or more aspects, systems, apparatuses, processes (also referred to as methods), and computer-readable media (collectively referred to herein as “systems and techniques”) are described herein for providing prior-guided MOEs. In one or more examples, the systems and techniques provide a gating regularization loss to inject priors into expert-execution patterns of MOEs for favorable on-device (e.g., on a resource-constrained device, such as a mobile device) execution. In some examples, the systems and techniques provide routing functions that enable more temporally consistent decisions. As such, the same expert in a layer (e.g., layer L) is more likely to be executed for adjacent tokens as well, which can make storing of experts (e.g., caching of experts) of resource-constrained devices more effective.

In one or more aspects, the systems and techniques utilize a gating regularization loss and routing functions to improve the training and on-device inference of MOE models. The systems and techniques inject priors into expert-execution patterns of MOEs. Using priors in such as way can makes MOEs favorable for on-device execution. Using priors can also enable more temporally consistent decisions, improving the hit rate of stored experts (e.g., cached experts).

In one or more aspects, during operation of the systems and techniques for language processing, a router of an MOE machine learning model can determine a distribution of tokens for a respective category associated with each expert layer of a plurality of expert layers of the MOE model. Each expert layer of the plurality of expert layers can be trained based on matching the distribution of tokens associated with each respective expert layer of the plurality of expert layers to a prior distribution of the tokens for the respective category associated with each respective expert layer of the plurality of expert layers (e.g., via a batch-shaping loss).

In some cases, the router can route to an expert layer of the plurality of expert layers based on a temporal expert activation pattern. In some examples, the temporal expert activation pattern is associated with the category. In some aspects, each token of the tokens is associated with a respective natural language word. In some cases, the category is a language translation category, a medical category, or a coding category. In one or more examples, each expert layer of the plurality of expert layers is associated with a respective feedforward network layer of the MOE model. In some examples, the distribution of tokens associated with each respective expert layer of the plurality of expert layers is based on a cumulative distribution function.

In one or more aspects, the systems and techniques may be employed for various different use cases. For example, any application requiring highly accurate text generation that would run efficiently on-device could benefit from utilizing the systems and techniques. In one or more examples, the systems and techniques may be applied to autonomous driving applications. For example, models with a large number of parameters that enable strong reasoning abilities are critical for autonomous driving applications. The on-device MOE solution of the systems and techniques can offer a large network capacity with a high accuracy, while also being efficient for deployment.

In some examples, the systems and techniques may be applied to complex tasks, such as language generation tasks, vision processing tasks, etc. For example, complex language generation tasks (e.g., such as code generation, writing documentation, question answering, among others) require high-capacity models to achieve a good accuracy. The MOE solution of the systems and techniques can allow for the deployment of high-capacity efficient MOE models on various types of computing platforms, such as resource-constrained computing devices.

Additional aspects of the present disclosure are described in more detail below.

As previously mentioned, deep learning machine learning models, such as LLMs, may be employed to perform a variety of tasks (e.g., detection and/or recognition of natural language, and natural language processing, among other natural language tasks). Deep learning machine learning models are versatile and may achieve high-quality accurate results in a variety of tasks. However, deep learning models can be large and slow and can have large memory and computational costs. The computational complexity of deep learning models can be high, and deep learning models can be difficult to train. In one or more cases, machine learning models can employ one or more transformers. Tokens can be used by a transformer as its base units for reasoning. For example, a natural language word can be associated with a token, which can be input into the transformer for processing.

Advances in machine learning, especially in natural language, have been achieved by increasing the computational budget, training data, and model size. Training state-of-the-art models, however, requires thousands of specialized, interconnected accelerators for weeks or months at a time. The models are therefore expensive to produce and incur high energy costs. As the scale of machine learning systems has increased, more efficient training and serving paradigms have been sought, such as sparse models.

LLMs enable a wide range of natural language processing tasks. However, deploying LLMs on mobile devices presents challenges due to their enormous parameter sizes, and significant memory and compute costs. Using MOEs (e.g., for LLMs or other types of machine learning models) can increase the number of parameters in a model (e.g., an LLM) without a proportional increase in computation during training and inference. For example, computational efficiency can be achieved by selectively activating (e.g., as in a sparse model) only a subset of parameters (or experts) for each input. Although MOEs (e.g., in a sparse model) provide computational benefits, as compared to dense models, MOEs have several challenges for training and on-device inference.

Currently, sparse expert models are a popular architecture in deep learning. The sparse expert model class of architecture encompasses MOEs. An MOE layer in an MOE architecture can include a set of experts, a routing mechanism (e.g., a routing network), and an optional loss function to balance the assignment of tokens to experts. For example, an MOE for an LLM may be designed by replacing an FFN layer in a transformer block with a set of expert FFN layers. The MOE model can include a gating/routing mechanism (e.g., a router or routing network) that dynamically determines which expert (or combination of experts) is best suited for a given input during inference. A switch transformer is a variant of an MOE layer using top-1 routing instead of top-k routing (where k≥2). Using a sparse expert model, the degree of sparsity decouples the parameter count from a compute per example allowing for extremely large, but efficient models. The resulting models have demonstrated significant improvements across diverse domains, such as natural language processing, computer vision, and speech recognition.

Sparse expert models, such as MOEs, are neural networks where a set of the parameters are partitioned into “experts”, each with a unique weight. During training and inference, the models route input examples to specific expert(s) weights. As a result, each example only interacts with a subset of the network parameters, converse to the usual approach, where the entire network is used for each input. Because only a fraction of the experts are used for each example, the amount of computation may remain small relative to the total model size.

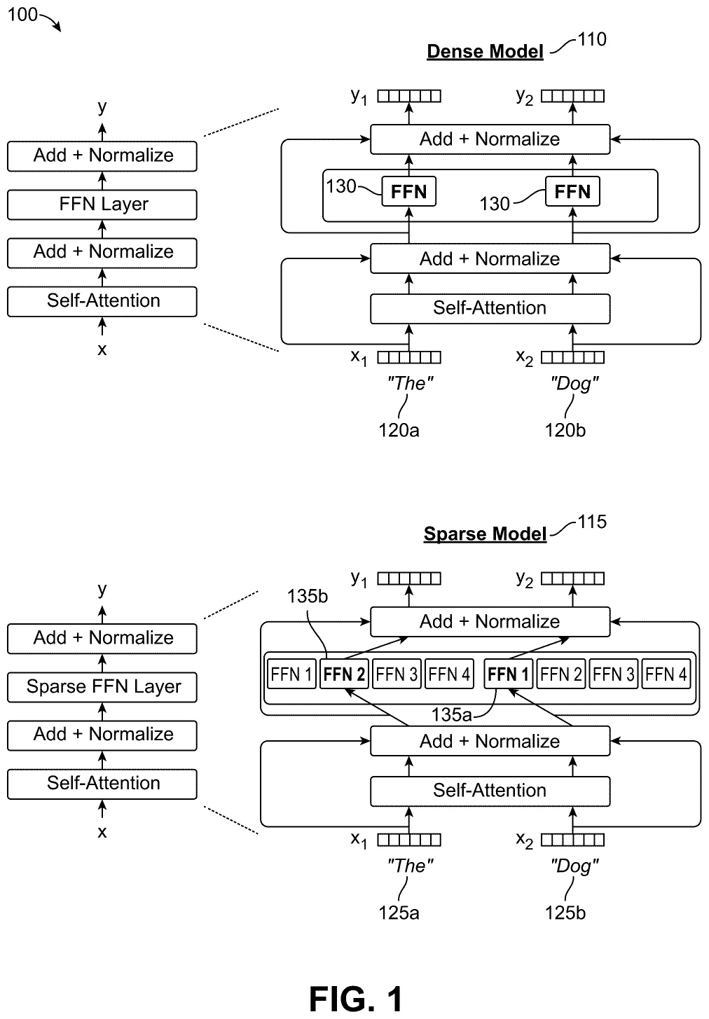

FIG. 1 is a diagram illustrating a comparison 100 between an example dense model 110 (e.g., in the form of a dense expert transformer) and an example sparse model 115 (e.g., in the form of a sparse expert transformer). In FIG. 1, tokens 120a, 120b, 125a, 125b can be used by the dense model 110 and the sparse model 115 as base units for reasoning. For example, a natural language word (e.g., “the” or “dog”) can be associated with a token 120a, 120b, 125a, 125b, which can be input into the dense model 110 and the sparse model 115 for processing.

In FIG. 1, the dense model 110 is shown to send both input tokens 120a, 120b (e.g., associated with the natural language words “the” and “dog”, respectively) to the same FFNs 130. Conversely, the sparse model 115 is shown to route each input token 125a, 125b (e.g., associated with the natural language words “the” and “dog”, respectively) independently amongst four experts (e.g., FFN 1 135a, FFN 2 135b, FFN 3, FFN 4). For example, in FIG. 1, the sparse model 115 is shown to route token 125a (e.g., associated with the natural language word “the”) to FFN 2 135b, and the sparse model 115 is shown to route token 125b (e.g., associated with the natural language word “dog”) to FFN 1 135a. In FIG. 1, each transformer (e.g., each of the dense model 110 and the model 115) uses a similar amount of computation, but the sparse model 115 has more unique parameters (e.g., experts) than the dense model 110.

As previously mentioned, the capacity of a neural network to absorb information is limited by the number of its parameters, and as a consequence, finding more effective ways to increase model parameters has become a trend in deep learning research. MOE (e.g., a type of conditional computation where parts of the network are activated on a per-example basis) has been used to dramatically increase model capacity without a proportional increase in computation. In sparsely activated variants of MOE models (e.g., the sparse model 115 in FIG. 1), a subset of experts is selected on a per-token (or per-example) basis, which creates sparsity in the network. Such models have demonstrated better scaling in multiple domains, and better retention capability in a continual learning setting.

MOEs (e.g., a sparse model) enable models to be pretrained with far less compute, which means that the model or dataset size can be dramatically scaled up with the same compute budget as a dense model. In particular, an MOE model should achieve the same quality as its dense counterpart much faster during pretraining. In the context of transformer models, MOEs include two main elements, including sparse MOE layers and a gate network or router. The terms “gate network” and “router” may be used interchangeably and/or may otherwise be used synonymously throughout various aspects described herein. The sparse MOE layers are used instead of dense FFN layers. MOE layers have a certain number of experts (e.g., eight experts), where each expert is a neural network. In practice, the experts are FFNs, but they can also be more complex networks or even an MOE itself.

MOEs operate by adopting a number of experts, each as a sub-network, and activating only one (or a few experts) for each input token. A gating network (e.g., a router or routing network) may be chosen and optimized in order to route each token to the most suited expert(s). Sparse MOEs (e.g., a sparse model) only select a subset of experts when routing each token, which reduces computational cost as compared to dense MOEs (e.g., a dense model).

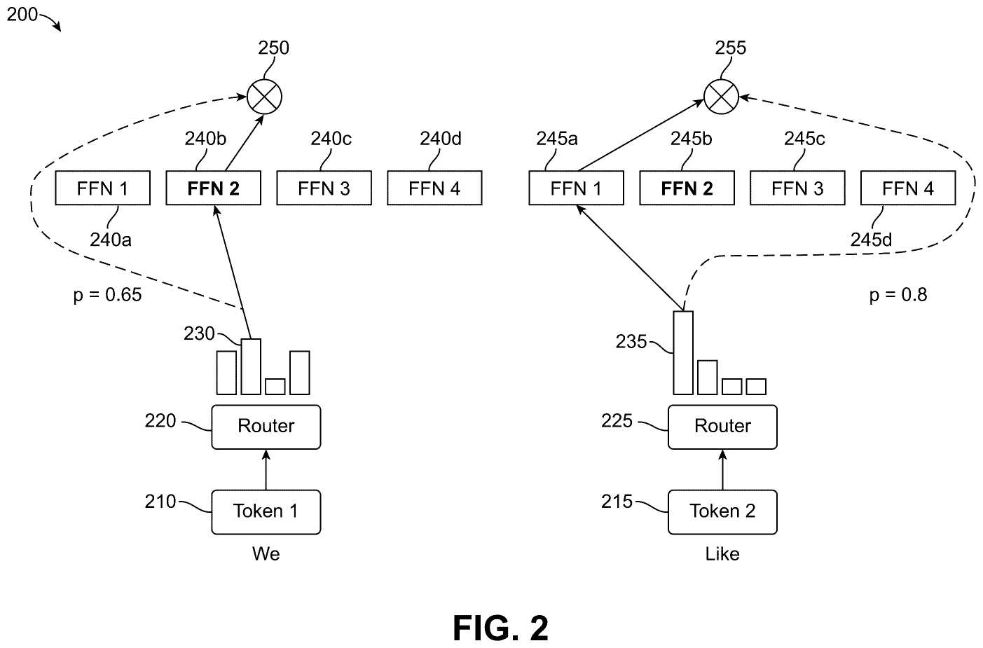

A gate network or router determines which tokens are sent to which expert(s). FIG. 2 shows an example of routers 220, 225 routing respective tokens 210, 215 to particular experts (e.g., FFN 2 240b and FFN 1 245a). In particular, FIG. 2 is a diagram illustrating an example of MOE token choice routing. In FIG. 2, a sparse switch FFN layer 200 is shown. A sparse MOE layer may employ the sparse switch FFN layer 200 of FIG. 2.

The sparse switch FFN layer 200 operates independently on the tokens 210, 215 in a sequence. The tokens 210, 215 are each associated with a natural language word. For example, token 210 is shown to be associated with the natural language word “we”, and token 215 is shown to be associated with the natural language word “like”.

In FIG. 2, the two tokens 210, 215 are shown to be routed across four FFN experts (e.g., among FFN 1 245a, FFN 2 245b, FFN 3 245c, and FFN 4 245d; and among FFN 1 245a, FFN 2 245b, FFN 3 245c, and FFN 4 245d), where each router 220, 225 independently routes each token 210, 215, respectively, based on a routing algorithm. The routing algorithm routes the tokens 210, 215 to maximize token-expert affinities. In one or more examples, the routing algorithm employs a token choice strategy (e.g., a top-k token routing strategy), where the routing algorithm selects the most suitable one (e.g., a top-one selection), two (e.g., a top-two selection), or several experts to route to for each token. For example, the routing algorithm can choose the top-one or top-two experts with the highest affinity scores (e.g., highest probability (p)) for each token. The affinity scores can be trained together with the model parameters. In one or more examples, the affinity scores (e.g., probabilities) can be passed through a Softmax algorithm such that the affinity scores (e.g., probabilities), when summed together, are equal to one (1.0).

In FIG. 2, the router 220 routes (e.g., sends) token 1 210 to the second expert (e.g., FFN 2 240b) of a plurality of experts (e.g., FFN 1 240a, FFN 2 240b, FFN 3 240c, and FFN 4 240d), based on the router gate value 230 with a probability p equal to 0.65. The remaining experts (e.g., FFN 1 240a, FFN 3 240c, and FFN 4 240d) do not perform any processing. The router 225 routes (e.g., sends) the token 2 215 to the first expert (e.g., FFN 1 245a) of a plurality of experts (e.g., FFN 1 245a, FFN 2 245b, FFN 3 245c, and FFN 4 245d), based on the router gate value 235 with a probability p equal to 0.8. The remaining experts (e.g., FFN 2 245b, FFN 3 245c, and FFN 4 245d) do not perform any processing.

The sparse switch FFN layer 200 then returns the output of the selected FFN expert multiplied by a router gate value. The sparse switch FFN layer 200 illustrates an example of top-1 routing. For example, the sparse switch FFN layer 200 returns the output of the selected FFN expert (e.g., FFN 2 240b) multiplied (e.g., by multiplier 250) by the router gate value 230 with a probability p equal to 0.65. The sparse switch FFN layer 200 returns the output of the selected FFN expert (e.g., FFN 1 245a) multiplied (e.g., by multiplier 255) by the router gate value 235 with a probability p equal to 0.8.

In one or more aspects, MOEs may have issues that arise during training. For example, training multi-billion parameter MOEs can present challenges related to stability and training time efficiency. For example, issues can emerge that include “expert collapse” (e.g., when only one expert is being used, and the remaining experts are not used and “collapse”) and prolonged training times. An alternative approach is to leverage existing knowledge from a dense model architecture to initialize the experts. Rather than initializing experts from scratch, the FFN can be replicated multiple times for expert initialization. However, during training, when the experts are merely identical, the router (e.g., a top-k router) may struggle to differentiate significantly between the experts, which can lead to redundancy and suboptimal expert performance.

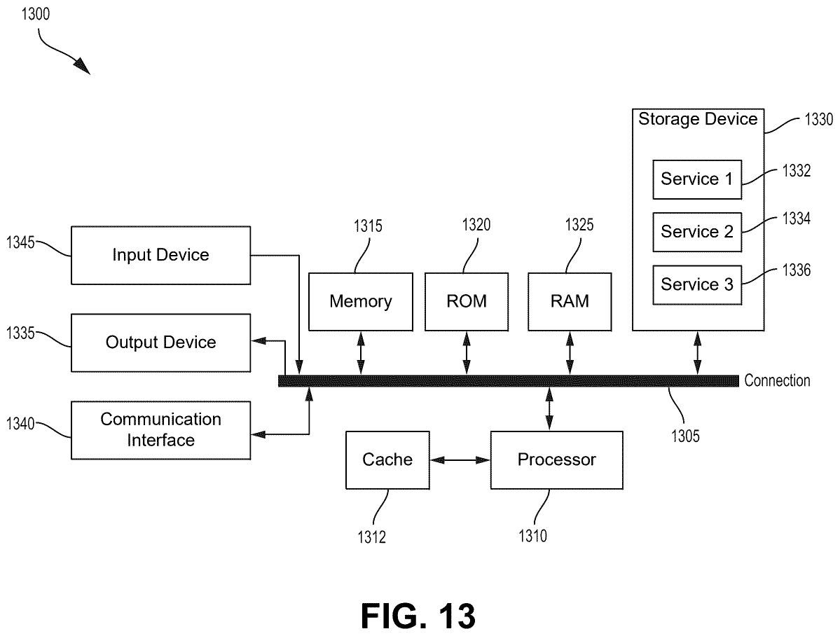

MOEs can have issues that arise during inference. For example, an issue (e.g., which arises during on-device inference) is the requirement of loading all of the parameters in RAM. For example, given an MOE architecture, such as Mixtral 8x7B, there needs to be enough VRAM (e.g., RAM 1325 of FIG. 13) sufficient to store a dense 47B parameter model (22 GB in 4-bit). As such, for memory-constraint devices, alternative solutions (e.g., such as pre-caching the experts) is required. The lack of consistency in activation of experts in the temporal dimension can result in a significant cache miss rate.

MOEs are currently trained (e.g., during inference) for batch deployment on servers, running across a large number of devices, where each device hosts a single (or a subset) of experts. It is desirable to have all experts activated in a balanced way to maximally use the available resources. Conversely, for mobile devices (e.g., smart phones), with resource constraints, that generate one token at a time, alternative priors for executing the experts is required. Improved predictability of the chosen experts and temporal consistency is highly desirable.

Therefore, improved systems and techniques, for devices with resource constraints, that employ priors for executing experts in MOEs can be useful.

In one or more aspects, the systems and techniques provide prior-guided MOEs. In one or more examples, the systems and techniques utilize a gating regularization loss to inject priors into expert-execution patterns of MOEs for favorable on-device (e.g., on a resource-constrained device, such as a mobile device) execution. In some examples, the systems and techniques employ routing functions that enable more temporally consistent decisions. As such, the same expert in a layer is more likely to be executed for adjacent tokens as well, which can make the caching of experts on resource-constrained devices more effective.

In one or more aspects, the systems and techniques use a gating regularization loss and routing functions to improve the training and on-device inference of MOE models. The systems and techniques inject priors into expert-execution patterns of MOEs, which makes MOEs favorable for on-device execution, and enable more temporally consistent decisions, which can improve the hit rate of cached experts.

In one or more aspects, during operation of the systems and techniques for language processing, a router, of a MOE machine learning model, may determine a distribution of tokens for a respective category associated with each expert layer of a plurality of expert layers of the MOE model. Each expert layer of the plurality of expert layers may be trained based on matching the distribution of tokens associated with each respective expert layer of the plurality of expert layers to a prior distribution of the tokens for the respective category associated with each respective expert layer of the plurality of expert layers (e.g., via a batch-shaping loss).

In one or more examples, the router may route to an expert layer of the plurality of expert layers based on a temporal expert activation pattern. In some examples, the temporal expert activation pattern is associated with the category. In one or more examples, each token of the tokens is associated with a respective natural language word. In some examples, the category is a language translation category, a medical category, or a coding category. In one or more examples, each expert layer of the plurality of expert layers is associated with a respective feedforward network layer of the MOE model. In some examples, the distribution of tokens associated with each respective expert layer of the plurality of expert layers is based on a cumulative distribution function.

In one or more aspects, the systems and techniques can enforce a prior on expert routing probabilities (e.g., p₁, p₂ . . . , p_{K} for each of the experts) to make MOEs more favorable for on-device execution. In one or more examples, a vector of routing probabilities p (in simplex) for K number of experts in an MOE layer can be given by:

$$p = \{ {p}_{1} , {p}_{2} ⋯ {p}_{K} \} , {\sum }_{i}^{K} {p}_{i} = 1$$

In one or more examples, each expert i has an associated probability distribution pᵢ. The probability distributions p₁, p₂ . . . , p_{K} for each of the experts can each be viewed from a categorical distribution (e.g., a Dirichlet distribution) at the vector p that is generated by the router. The systems and techniques described herein can inject a prior over the categorical distribution. For instance, in some aspects, the systems and techniques can impose the prior (e.g., a prior probability) on the categorical distribution (e.g., Dirichlet distribution) by incorporating a Dirichlet-multinomial prior for the probabilities. The prior Dirichlet distribution (e.g., prior distribution of probabilities) has a vector parameter α=(α₁, α₂, . . . , αₖ), where each αₖ>0, and A=Σₖαₖ. The probability distribution function (PDF) of the Dirichlet distribution can be given by:

$$f ( p ; α ) - \frac{1}{B ( α )} {\prod }_{i = 1}^{K} {p}_{i}^{{α}_{i} - 1}$$

The value of at influences the shape of the distribution controlling the concentration or spread of probabilities around the mean. Intuitively, αᵢ reflects the strength or prior belief associated with an expert i (e.g., reflects how strongly it is desired to activate an expert i).

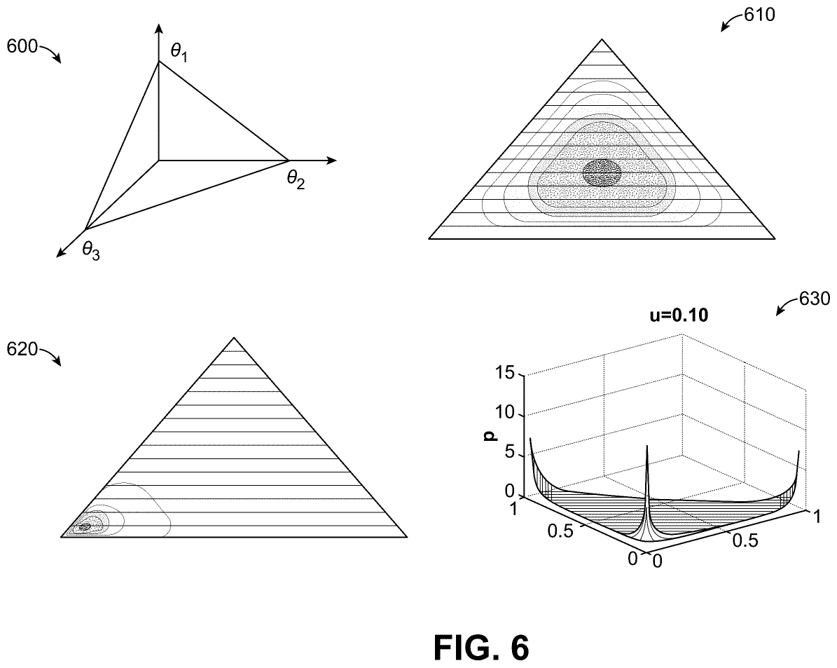

As noted previously, each expert i can have an associated probability distribution pᵢ. For instance, it may be desirable, during training, to inject a prior that an expert 1 and an expert 2 (e.g., associated with p₁ and p₂, respectively) are more often used than other experts for a particular coding task. A Dirichlet-multinomial prior can be incorporated for the probabilities (e.g., p₁ and p₂). The Dirichlet distribution (e.g., Dirichlet distribution 600 of FIG. 6) has a vector parameter α=(α₁, α₂, . . . , αₖ), which reflects how strongly an expert i should be activated. Unlike the vector p={p₁, p₂ . . . , p_{K}}, the vector α=(α₁, α₂, . . . , αₖ) does not need to have a sum equal to one (1.0). As such, the size of the values α₁, α₂, . . . , αₖ can determine how peaky the distribution should be around each expert. The systems and techniques can thus utilize a Dirichlet distribution with a specific prior, which can be controlled with the set of parameters di.

In one or more examples, the marginals of the Dirichlet distribution are Beta distributions, and therefore, the marginal distribution for expert i can be expressed as the following beta distribution:

$${p}_{i} \sim Beta ( {α}_{i} , A - {α}_{i} )$$

The Beta distribution is a bimodal distribution, which indicates how much of the concentration is around zero. The first parameter of the Beta distribution, at, indicates the strength of an expert being “on” (e.g., activated) for processing data (e.g., related to a particular task), and the second parameter of the Beta distribution, A−αᵢ, indicates the strength of an expert being “off” (e.g., not activated) for processing data (e.g., related to a particular task). The probability of an expert being “on” can be expressed as

$$\frac{{α}_{i}}{A}$$

the probability of the expert being off can be expressed as

$$\frac{A - {α}_{i}}{A} .$$

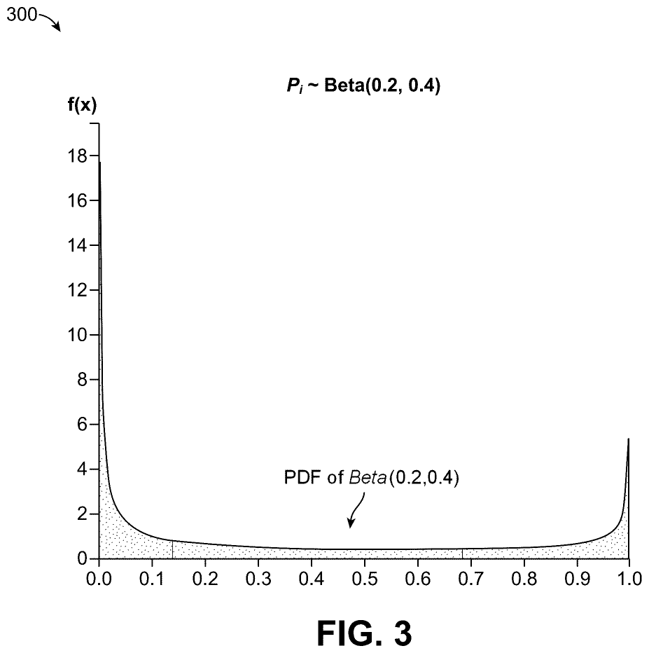

In one or more examples, suppose for three experts, there is a prior Dirichlet distribution with vector parameter α. FIGS. 3, 4, and 5 show examples of probabilities density functions (PDFs) of Beta distributions for each expert i (of a total of three experts) for different cases (e.g., case 1, case 2, and case 3) with different vector parameters a.

In particular, FIG. 3 is a diagram illustrating an example of a Beta distribution 300 for three experts for case 1 with vector parameter α=(0.2, 0.2, 0.2). In FIG. 3, the Beta distribution 300 is shown for each of the three experts (e.g., each of the three experts has the same Beta distribution 300). The Beta distribution 300 shows that the experts (e.g., expert 1, expert 2, and expert 3) will be inactive (e.g., “off”) for 66.6 percent (%) of the data

$$( e . g . , \frac{b}{( a + b )}$$

given a beta distribution of Beta(a,b)), and the expert (e.g., expert 1, expert 2, and expert 3) will be active (e.g., “on”) for 33.3% of the data

$$( e . g . , \frac{a}{( a + b )}$$

given a beta distribution of Beta(a,b)).

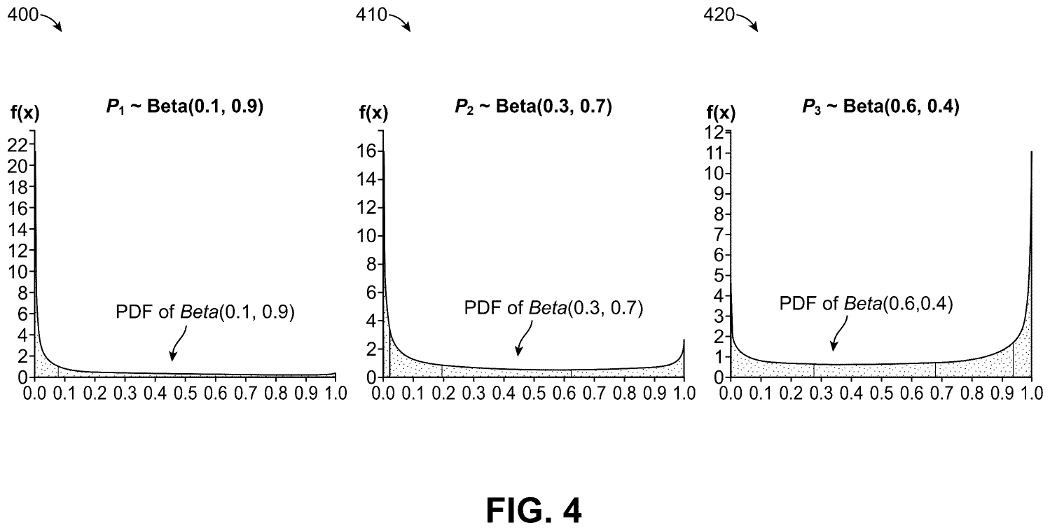

FIG. 4 is a diagram illustrating an example of three Beta distributions 400, 410, 420 for three experts, respectively, for case 2 with vector parameter α=(0.1, 0.3, 0.6). In FIG. 4, the Beta distribution 400 is shown for expert 1, the Beta distribution 410 is shown to expert 2, and the Beta distribution 420 is shown for expert 3.

The Beta distribution 400 shows that expert 1 will be inactive (e.g., “off”) for 90% of the data, and expert 1 will be active (e.g., “on”) for only 10% of the data. The Beta distribution 410 shows that expert 2 will be inactive (e.g., “off”) for 70% of the data, and expert 2 will be active (e.g., “on”) for 30% of the data. The Beta distribution 420 shows that expert 3 will be inactive (e.g., “off”) for 40% of the data, and expert 2 will be active (e.g., “on”) for 60% of the data.

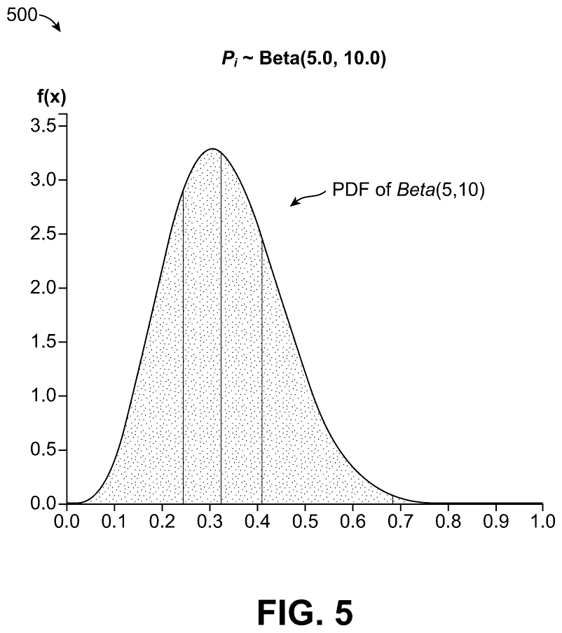

FIG. 5 is a diagram illustrating another example of a Beta distribution 500 for three experts for case 3 with vector parameter α=(5, 5, 5). In FIG. 5, the Beta distribution 500 is shown for each of the three experts (e.g., each of the three experts has the same Beta distribution 500). The Beta distribution 500 shows that, on average, the experts (e.g., expert 1, expert 2, and expert 3) will be active (e.g., “on”) for approximately 33.3% of the data.

In one or more examples, a multivariate generalization of the Beta distribution is the Dirichlet distribution, which has support over a probability simplex. FIG. 6 is a diagram illustrating an example of a Dirichlet distribution 600 and plots of example Dirichlet densities 610, 620, 630. In FIG. 6, an example of a Dirichlet distribution 600 is shown when three experts (e.g., K=3) define a distribution over the simplex, which can be represented by a triangular surface. FIG. 6 also shows a plot of a Dirichlet density 610 when α=(2, 2, 2), a plot of a Dirichlet density 620 when α=(20, 2, 2), and a plot of a Dirichlet density 630 when α=(0.1, 0.1, 0, 1). The comb-like structure shown on the edges of the Dirichlet density 630 is a plotting artifact.

In one or more aspects, the output distribution of the gate (e.g., router) can be matched to a specific prior (e.g., via a batch-shaping loss or other loss function). For instance, the distance between the cumulative distribution function (CDF) of the target Beta distribution for each expert and the empirical CDF of the gate output for the corresponding expert can be minimized. The batch-shaping loss can be given by:

$${L}_{batch - shaping} = {\sum }_{b - 1}^{B} {[ {\hat{F}}_{n} ( {p}_{i , b} ) - F ( {p}_{i , b} ) ]}^{2}$$

where \hat{F}ₙ(p_{i,b}) is the empirical CDF value at p_{i,b}, and F(p_{i,b}) is the CDF of the prior distribution evaluated at p_{i,b}.

In some examples, a hyper-prior version can be used where σ can control the variance of vector parameter α. The case of σ=0 denotes an identical prior for all αᵢ (e.g., α=(0.2, 0.2, 0.2)). The hyper-prior can be controlled to deviate from the identical prior to favor some experts more than others, if necessary.

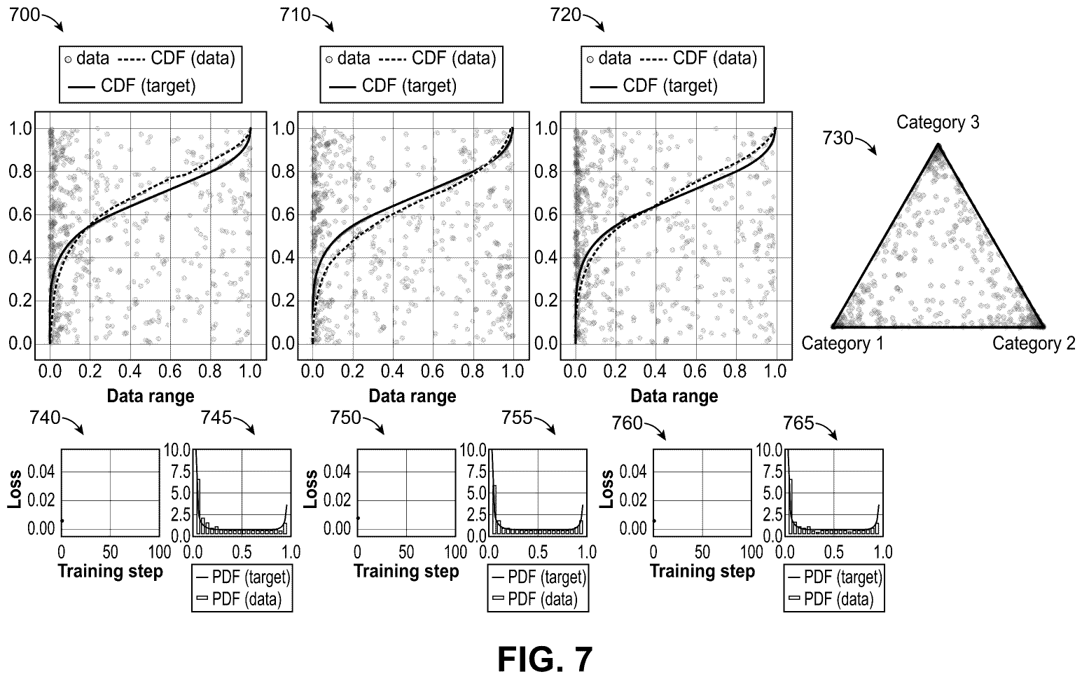

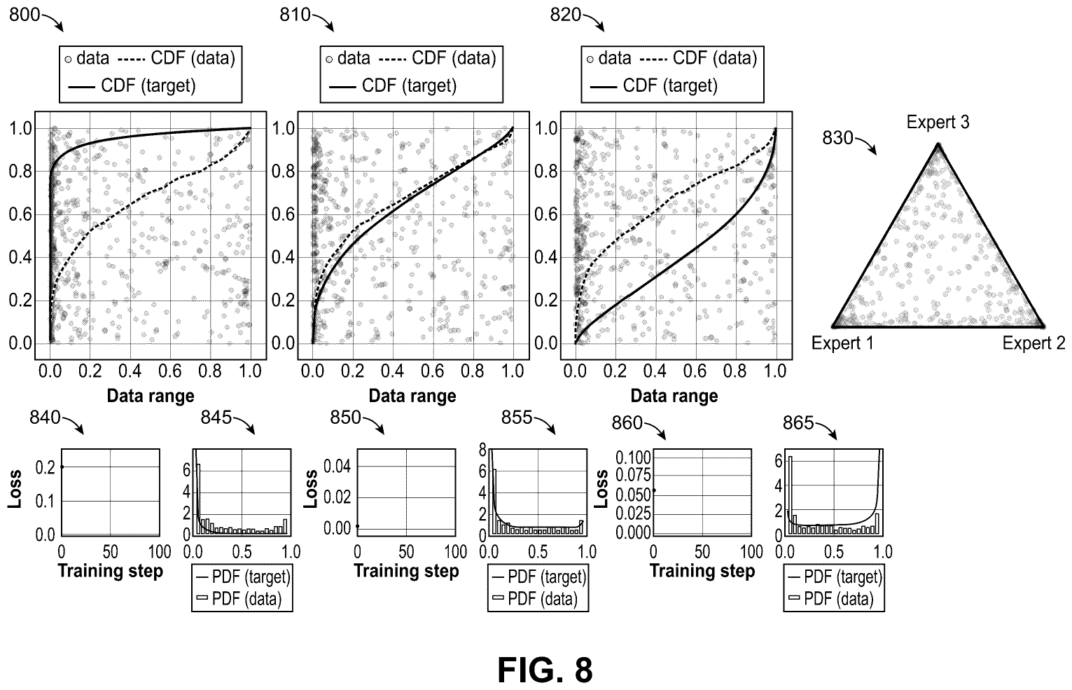

FIGS. 7 and 8 show examples of batch-shaping for learning (e.g., during training) using a batch-shaping loss, where the distance between the CDF of a target prior Beta distribution (e.g., target CDF, such as for a plurality of tokens of a category) for each expert and the empirical CDF of the router output for the corresponding expert (e.g., CDF data, such as for the plurality of tokens for the category) is minimized such that the CDF data will match the target CDF. In one or more examples, the target CDF can be calculated from a target PDF (e.g., prior PDF) for each expert.

In particular, FIG. 7 is a diagram illustrating an example of producing a data distribution for three experts, where all three experts are active. In FIG. 7, CDF graphs 700, 710, 720; training graphs 740, 750, 760; PDF graphs 745, 755, 765; and an expert distribution diagram 730 are shown. The CDF graphs 700, 710, 720 each include a CDF target curve and a CDF data curve. The CDF target curve represents a target prior Beta distribution (e.g., for a plurality of tokens of a category) for a particular expert (e.g., expert 1). The CDF data curve represents the empirical CDF (e.g., for the plurality of tokens for the category) of the router output for the particular expert (e.g., expert 1). In one or more examples, the tokens are each a respective natural language word. In some examples, the category is a language translation category (e.g., including tokens related to language), a medical category (e.g., including tokens related to medical terms), or a coding category (e.g., including tokens related to coding terms).

In FIG. 7, the training graphs 740, 750, 760 each plot the training steps versus the batch-shaping loss. At the end of the training steps, the batch-shaping loss should be at zero. The PDF graphs 745, 755, 765 each include a PDF target curve and PDF data.

In FIG. 7, the CDF graph 700, training graph 740, and the PDF graph 745 are associated with expert 1. The CDF graph 710, training graph 750, and the PDF graph 755 are associated with expert 2. The CDF graph 720, training graph 760, and the PDF graph 765 are associated with expert 3.

During training of the MOE model, the distance between the CDF of a target prior Beta distribution (e.g., target CDF) for each expert and the empirical CDF of the router output for the corresponding expert (e.g., CDF data) is minimized such that the CDF data will match the target CDF (e.g., the CDF data curve will match the corresponding target CDF curve). After the training of the MOE model is complete, the expert distribution diagram 730 shows the resultant distribution of the tokens amongst the experts (e.g., category 1, category 2, and category 3). As shown in the expert distribution diagram 730 the tokens are more or less equally distributed amongst the three experts (e.g., the three experts are equally active for processing the tokens such that each expert will process approximately 30% of the tokens).

FIG. 8 is a diagram illustrating an example of producing a data distribution for three experts, where two (e.g., experts 2 and 3) of the three experts are active (e.g., one of the three experts, for example expert 1, is deactivated). In FIG. 8, CDF graphs 800, 810, 820; training graphs 840, 850, 860; PDF graphs 845, 855, 865; and an expert distribution diagram 830 are shown. Each of the CDF graphs 800, 810, 820 includes a CDF target curve and a CDF data curve. The CDF target curve represents a target prior Beta distribution (e.g., for a plurality of tokens of a category) for a particular expert (e.g., expert 1). The CDF data curve represents the empirical CDF (e.g., for the plurality of tokens for the category) of the router output for the particular expert (e.g., expert 1). In one or more examples, the tokens are each a respective natural language word. In some examples, the category is a language translation category (e.g., including tokens related to language), a medical category (e.g., including tokens related to medical terms), or a coding category (e.g., including tokens related to coding terms).

In FIG. 8, the training graphs 840, 850, 860 each plot the training steps versus the batch-shaping loss. At the end of the training steps, the batch-shaping loss should be at zero. The PDF graphs 845, 855, 865 each include a PDF target curve and PDF data.

In FIG. 8, the CDF graph 800, training graph 840, and the PDF graph 845 are associated with expert 1. Because expert 1 is deactivated, the CDF target curve in the CDF graph 800 shows that expert 1 is “off” (e.g., not activated) for processing most of the data. The CDF graph 810, training graph 850, and the PDF graph 855 are associated with expert 2. The CDF graph 820, training graph 860, and the PDF graph 865 are associated with expert 3.

During training of the MOE model, the the distance between the CDF of a target prior Beta distribution (e.g., target CDF) for each expert and the empirical CDF of the router output for the corresponding expert (e.g., CDF data) is minimized such that the CDF data will match the target CDF (e.g., the CDF data curve will match the corresponding target CDF curve). After the training of the MOE model is complete, the expert distribution diagram 830 shows the resultant distribution of the tokens amongst the experts (e.g., category 1, category 2, and category 3). The resultant expert distribution diagram 830 relates to the Beta distributions 400, 410, and 420 illustrated in FIG. 4. For example, at the end of training, expert 2 will be active (e.g., “on”) for 30% of the data, expert 3 will be active for 60% of the data, and expert 1 will be active for 10% of the data.

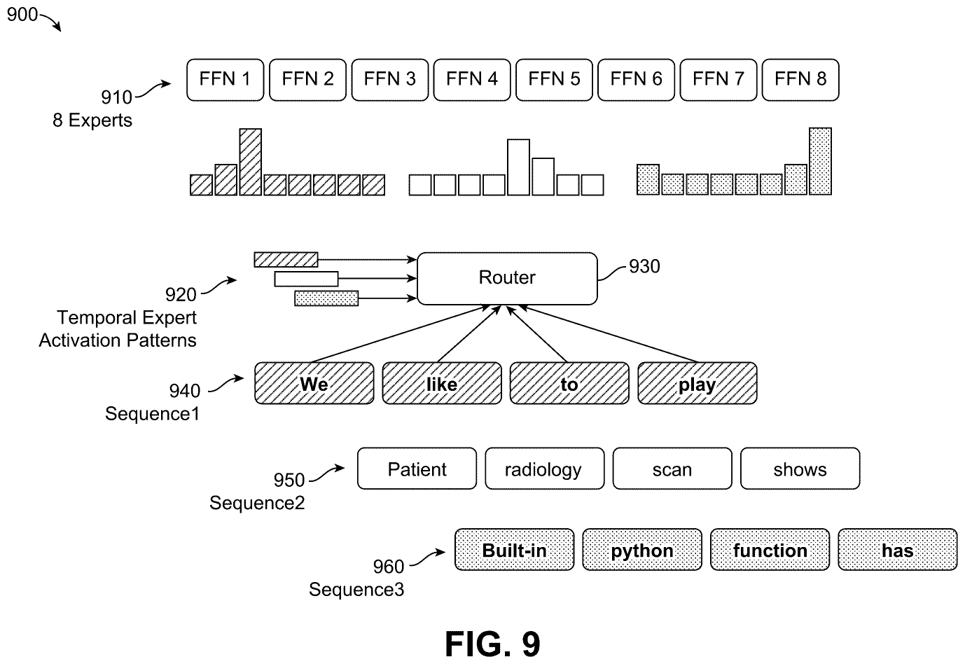

In one or more aspects, the systems and techniques can utilize a temporal consistency for executing the experts. FIG. 9 is a diagram illustrating an example of a model 900 that can route tokens (e.g., associated with different sequences 940, 950, 960) to experts 910 (e.g., FFN 1, FFN 2, FFN 3, FFN 4, FFN 5, FFN 6, FFN 7, FFN 8) based on temporal expert activation patterns 920. The example of FIG. 9 illustrates temporal consistency. In FIG. 9, each sequence 940, 950, 960 is associated with a specific task type (or category). For example, sequence 1 940 is associated with a language translation task type (or category) and includes tokens that are related to language. Sequence 2 950 is associated with a medical task type (or category) and includes tokens that are related to medical terms. Sequence 3 960 is associated with a coding task type (or category) and includes tokens that are related to coding terms.

During operation of the model 900 of FIG. 9, the router 930 can receive, as input, the temporal expert activation patterns 920. Each temporal expert activation pattern 920 is associated with a particular task type (or category) of tokens. The temporal expert activation patterns 920 can regularize the router 930 to make more consistent decisions across the temporal dimension. The router 930 can use the temporal expert activation patterns 920 to make experts become more task specific (e.g., some experts can specialize in coding tasks, language translation tasks, and/or medical tasks). For example, according to sequence 1 940, the router 930 may route the language translation related tokens to experts 2 and 3. According to sequence 2 950, the router 930 may route the medical related tokens to experts 5 and 6. According to sequence 3 960, the router 930 may route the coding related tokens to experts 7 and 8.

In one or more examples, the history of activation of experts for a specific task type (or category) of tokens can be used as input to the router 930 to generate more temporally consistent utilization of experts. For example, the temporal expert activation patterns 920 can make the router 930 aware that a specific expert (e.g., expert 1) has been previously used for a specific task type (or category) of tokens. The router 930 can use such information to route the same expert (e.g., expert 1) for that specific task type (or category) of tokens such that different experts do not need to be switched out of the cache (e.g., dynamic random-access memory (DRAM)). Temporally consistent routing, by the router 930, can be beneficial for on-device scenarios and can improve the hit rate of cached experts.

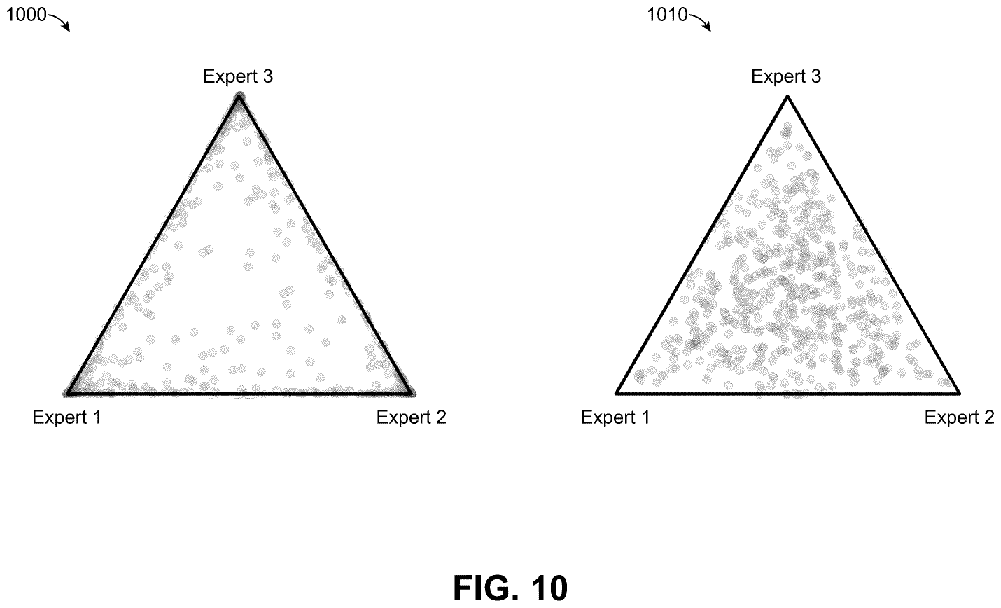

FIG. 10 is a diagram illustrating a comparison between an example data distribution 1000 for three experts produced using a batch-shaping loss and an example data distribution 1010 for three experts produced using a load-balancing loss. In FIG. 10, the data distribution 1000 shows the resultant distribution of the tokens amongst three experts (e.g., expert 1, expert 2, and expert 3) after training of the MOE model using a batch-shaping loss. The data distribution 1010 shows the resultant distribution of the tokens amongst three experts (e.g., expert 1, expert 2, and expert 3) after training of the MOE model using a load-balancing loss.

As shown in FIG. 10, in the data distribution 1000, the tokens are more or less equally distributed amongst the three experts (e.g., the three experts are equally active for processing the tokens such that each expert will process approximately 30% of the tokens). Conversely, in the data distribution 1010, the tokens are approximately evenly distributed throughout the data distribution 1010. As such, the model is not certain regarding which expert should process the tokens located near the center of the data distribution 1010. In contrast to the data distribution 1000, the data distribution 1010 does not provide a definitive distribution of most of the tokens amongst the experts.

In one or more aspects, machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others. Different types of neural networks exist, such as convolutional neural networks (CNNs), recurrent neural networks (RNNs), generative adversarial networks (GANs), multilayer perceptron (MLP) neural networks, transformer neural networks, among others.

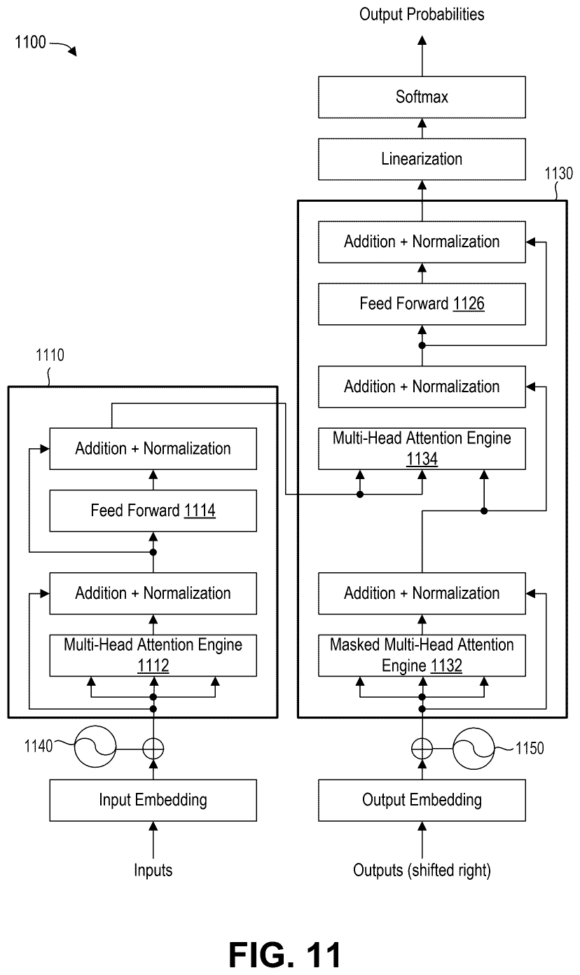

As described herein, an MOE model can utilize one or more transformers (e.g., a transformer block can include a set of expert feedforward network (FFN) layers). FIG. 11 is a block diagram of an example transformer. In a convolutional neural network (CNN) model, the number of operations required to relate signals from two arbitrary input or output positions grows in the distance between positions, which makes learning dependencies at different distant positions challenging for a CNN model. A transformer 1100 reduces the operations of learning dependencies by using an encoder 1110 and a decoder 1130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1110 is composed of a stack of six identical layers and each layer has two sub-layers. The first sub-layer is a multi-head self-attention engine 1112, and the second sub-layer is a fully connected feed-forward network 1114. A residual connection (not shown) connects around each of the sub-layers followed by normalization.

In the example transformer 1100, the decoder 1130 is also composed of a stack of six (6) identical layers. The decoder also includes a masked multi-head self-attention engine 1132, a multi-head attention engine 1134 over the output of the encoder 1110, and a fully connected feed-forward network 1126. Each layer includes a residual connection (not shown) around the layer, which is followed by layer normalization. The masked multi-head self-attention engine 1132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1140 to encode positions because the model does not contain recurrence and convolution and relative or absolute position of the tokens is needed. In the transformer 1100, the positional encodings are added to the input embeddings at the bottom layer of the encoder 1110 and the decoder 1130. The positional encodings are summed with the embeddings because the positional encodings and embeddings have the same dimensions. A corresponding position decoder 1150 is configured to decode the positions of the embeddings for the decoder 1130.

In some aspects, the transformer 1100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1100 can process input sequences of variable length, making it well-suited for natural language processing tasks where input lengths can vary greatly. Additionally, the self-attention mechanism allows the transformer 1100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

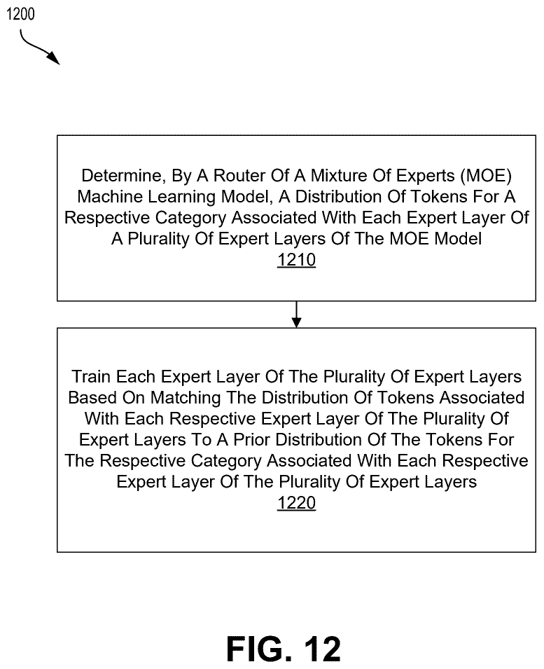

FIG. 12 is a flow chart illustrating an example of a process 1200 for prior-guided MOEs. In some examples, the process 1200 may be performed by a computing device or apparatus or a component or system (e.g., the sparse model 115 of FIG. 1, the model 900 of FIG. 9, the transformer 1100 of FIG. 11, one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device or apparatus. In some examples, the computing system 1300 of FIG. 13 can perform the process 1200 of FIG. 12. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be a system on a chip (SOC), the computing system 1300 of FIG. 13, and/or other computing device or apparatus.

At block 1210, the computing device (or component thereof) can determine, using a router (or gate) of an MOE machine learning model, a distribution of tokens for a respective category associated with each expert layer of a plurality of expert layers of the MOE model. For instance, the respective category associated with each expert layer can be a language translation category, a medical category, a coding category, and/or other type of category. In some aspects, each expert layer of the plurality of expert layers is associated with a respective feedforward network layer of the MOE model. In some cases, the at least one processor is configured to route, using the router, at least one token to an expert layer of the plurality of expert layers based on a temporal expert activation pattern. In some examples, the temporal expert activation pattern is associated with a category associated with the expert layer. In some cases, each token of the tokens is associated with a respective natural language word.

At block 1220, the computing device (or component thereof) can train each expert layer of the plurality of expert layers based on matching the distribution of tokens associated with each respective expert layer of the plurality of expert layers to a prior distribution of the tokens for the respective category associated with each respective expert layer of the plurality of expert layers. For instance, as described herein, the computing device (or component thereof) can enforce a prior on expert routing probabilities (e.g., p₁, p₂ . . . , p_{K} for each of the experts) to make MOEs more favorable for on-device execution. In some cases, the computing device (or component thereof) can train each expert layer of the plurality of expert layers using a batch-shaping loss. In some aspects, the output distribution of the router (or gate) can be matched to a specific prior (e.g., via the batch-shaping loss). In some aspects, the distribution of tokens associated with each respective expert layer of the plurality of expert layers is based on a cumulative distribution function (CDF). For instance, a distance between the CDF of a target Beta distribution for each expert and an empirical CDF of the gate output for the corresponding expert can be minimized.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for prior-guided MOEs. In particular, FIG. 13 illustrates an example of computing system 1300, which can be for example any computing device making up internal computing system, a remote computing system, a neural network, a machine learning model (e.g., a MOE model, such as the sparse model 115 of FIG. 1), a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random-access memory (RAM) 1325 to processor 1310. Computing system 1300 can include a cache 1312 of high-speed memory connected directly with, in close proximity to, or integrated as part of processor 1310.

Processor 1310 can include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding or incorporated in a combined video encoder-decoder (CODEC).

Illustrative aspects of the disclosure include:

Aspect 1. An apparatus for machine-learning processing, the apparatus comprising: at least one memory; and at least one processor coupled to the at least one memory and configured to: determine, using a router of a mixture of experts (MOE) machine learning model, a distribution of tokens for a respective category associated with each expert layer of a plurality of expert layers of the MOE model; and train each expert layer of the plurality of expert layers based on matching the distribution of tokens associated with each respective expert layer of the plurality of expert layers to a prior distribution of the tokens for the respective category associated with each respective expert layer of the plurality of expert layers.

Aspect 2. The apparatus of Aspect 1, wherein the at least one processor is configured to route, using the router, at least one token to an expert layer of the plurality of expert layers based on a temporal expert activation pattern.

Aspect 3. The apparatus of Aspect 2, wherein the temporal expert activation pattern is associated with a category associated with the expert layer.

Aspect 4. The apparatus of any of Aspects 1 to 3, wherein each token of the tokens is associated with a respective natural language word.

Aspect 5. The apparatus of any of Aspects 1 to 4, wherein the respective category associated with each expert layer is at least one of a language translation category, a medical category, or a coding category.

Aspect 6. The apparatus of any of Aspects 1 to 5, wherein each expert layer of the plurality of expert layers is associated with a respective feedforward network layer of the MOE model.

Aspect 7. The apparatus of any of Aspects 1 to 6, wherein the distribution of tokens associated with each respective expert layer of the plurality of expert layers is based on a cumulative distribution function.

Aspect 8. The apparatus of Aspects 1 to 7, wherein the at least one processor is configured to train each expert layer of the plurality of expert layers using a batch-shaping loss.

Aspect 9. A method of machine-learning processing, the method comprising: determining, by a router of a mixture of experts (MOE) machine learning model, a distribution of tokens for a respective category associated with each expert layer of a plurality of expert layers of the MOE model; and training each expert layer of the plurality of expert layers based on matching the distribution of tokens associated with each respective expert layer of the plurality of expert layers to a prior distribution of the tokens for the respective category associated with each respective expert layer of the plurality of expert layers.

Aspect 10. The method of Aspect 9, further comprising routing, by the router, at least one token to an expert layer of the plurality of expert layers based on a temporal expert activation pattern.

Aspect 11. The method of Aspect 10, wherein the temporal expert activation pattern is associated with a category associated with the expert layer.

Aspect 12. The method of any of Aspects 9 to 11, wherein each token of the tokens is associated with a respective natural language word.

Aspect 13. The method of any of Aspects 9 to 12, wherein the respective category associated with each expert layer is at least one of a language translation category, a medical category, or a coding category.

Aspect 14. The method of any of Aspects 9 to 13, wherein each expert layer of the plurality of expert layers is associated with a respective feedforward network layer of the MOE model.

Aspect 15. The method of any of Aspects 9 to 14, wherein the distribution of tokens associated with each respective expert layer of the plurality of expert layers is based on a cumulative distribution function.

Aspect 16. The method of any of Aspects 9 to 15, wherein each expert layer of the plurality of expert layers is trained using a batch-shaping loss.

Aspect 17. A non-transitory computer-readable medium having stored thereon instructions that, when executed by at least one processor, cause the at least one processor to perform operations according to any of Aspects 9 to 16.

Aspect 18. An apparatus for machine-learning processing, the apparatus comprising one or more means for performing operations according to any of Aspects 9 to 16.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for machine-learning processing, the apparatus comprising:
at least one memory; and
at least one processor coupled to the at least one memory and configured to:
determine, using a router of a mixture of experts (MOE) machine learning model, a distribution of tokens for a respective category associated with each expert layer of a plurality of expert layers of the MOE model; and
train each expert layer of the plurality of expert layers based on matching the distribution of tokens associated with each respective expert layer of the plurality of expert layers to a prior distribution of the tokens for the respective category associated with each respective expert layer of the plurality of expert layers.

2. The apparatus of claim 1, wherein the at least one processor is configured to route, using the router, at least one token to an expert layer of the plurality of expert layers based on a temporal expert activation pattern.

3. The apparatus of claim 2, wherein the temporal expert activation pattern is associated with a category associated with the expert layer.

4. The apparatus of claim 1, wherein each token of the tokens is associated with a respective natural language word.

5. The apparatus of claim 1, wherein the respective category associated with each expert layer is at least one of a language translation category, a medical category, or a coding category.

6. The apparatus of claim 1, wherein each expert layer of the plurality of expert layers is associated with a respective feedforward network layer of the MOE model.

7. The apparatus of claim 1, wherein the distribution of tokens associated with each respective expert layer of the plurality of expert layers is based on a cumulative distribution function.

8. The apparatus of claim 1, wherein the at least one processor is configured to train each expert layer of the plurality of expert layers using a batch-shaping loss.

9. A method of machine-learning processing, the method comprising:
determining, by a router of a mixture of experts (MOE) machine learning model, a distribution of tokens for a respective category associated with each expert layer of a plurality of expert layers of the MOE model; and
training each expert layer of the plurality of expert layers based on matching the distribution of tokens associated with each respective expert layer of the plurality of expert layers to a prior distribution of the tokens for the respective category associated with each respective expert layer of the plurality of expert layers.

10. The method of claim 9, further comprising routing, by the router, at least one token to an expert layer of the plurality of expert layers based on a temporal expert activation pattern.

11. The method of claim 10, wherein the temporal expert activation pattern is associated with a category associated with the expert layer.

12. The method of claim 9, wherein each token of the tokens is associated with a respective natural language word.

13. The method of claim 9, wherein the respective category associated with each expert layer is at least one of a language translation category, a medical category, or a coding category.

14. The method of claim 9, wherein each expert layer of the plurality of expert layers is associated with a respective feedforward network layer of the MOE model.

15. The method of claim 9, wherein the distribution of tokens associated with each respective expert layer of the plurality of expert layers is based on a cumulative distribution function.

16. The method of claim 9, wherein each expert layer of the plurality of expert layers is trained using a batch-shaping loss.

17. An apparatus for machine-learning processing, the apparatus comprising:
means for determining a distribution of tokens for a respective category associated with each expert layer of a plurality of expert layers of a mixture of experts (MOE) machine learning model; and
means for training each expert layer of the plurality of expert layers based on matching the distribution of tokens associated with each respective expert layer of the plurality of expert layers to a prior distribution of the tokens for the respective category associated with each respective expert layer of the plurality of expert layers.

18. The apparatus of claim 17, further comprising means for routing at least one token to an expert layer of the plurality of expert layers based on a temporal expert activation pattern.

19. The apparatus of claim 18, wherein the temporal expert activation pattern is associated with a category associated with the expert layer.

20. The apparatus of claim 17, wherein each expert layer of the plurality of expert layers is associated with a respective feedforward network layer of the MOE model.
